(19) United States
(12) Patent Application Publication
(10) Pub. No.: US 2019/0384621 A1
(43) Pub. Date: Dec. 19, 2019

(54) NEXT OPERATION PREDICTION FOR A WORKFLOW

(71) Applicant: Microsoft Technology Licensing, LLC, Redmond, WA (US)

(72) Inventors: Liang CHEN, Bellevue, WA (US); Michael Edward HARNISCH, Seattle, WA (US); Jose Alberto RODRIGUEZ, Seattle, WA (US); Steven Douglas DEMAR, Redmond, WA (US)

(21) Appl. No.: 16/008,851

(22) Filed: Jun. 14, 2018

(51) Int. Cl. G06F 9/451; G06F 3/0482; G06F 3/0483

(52) U.S. Cl. CPC G06F 9/453; G06F 3/0483; G06F 3/0482

(57) ABSTRACT

The disclosed technology predicts and presents a next operation for a set window of associated application windows. An operation prediction system adds multiple associated application windows to the set window, generates a prediction of one or more next operation options based on the associated application windows of the set window, presents one or more controls to the one or more next operation options in the user interface of the computing device, detects user selection of a control of the presented next operation options, executes in the set window the next operation option corresponding to the selected control, responsive to communicating the detecting operation.

### CROSS-REFERENCE TO RELATED APPLICATIONS

The present application is related to U.S. application Ser. No. ______ [Docket No. 404361-US-NP], entitled “Inter-application Context Seeding”; U.S. application Ser. No. ______ [Docket No. 404368-US-NP], entitled “Surfacing Application Functionality for an Object”; and U.S. application Ser. No. ______ [Docket No. 404710-US-NP], entitled “Predictive Application Functionality Surfacing,” all of which are concurrently filed herewith and incorporated herein by reference for all that they disclose and teach.

### BACKGROUND

Many user workflows involve multiple applications in multiple application windows working together to achieve the user's objective. A set of multiple associated application windows can help focus and coordinate such efforts. For example, a user can open multiple browser windows and a presentation editor application window in a set of associated application windows, which can, for example, be tagged within the set or be detached while remaining logically in the set of associated application windows. In this example, the user may be using the associated application windows in the set to create a presentation in the presentation editor application window and to search and copy images from one or more image gallery websites via the browser windows. The set can save the state of the associated application windows, open on different computing devices, and provide a unified workplace in which the user can focus on his or her workflow.

### Summary

The characteristics of a set of associated applications windows, the content of those application windows, and the historical activity in the set (and similar sets) can assist in determining user intents and allow suggestion of possible next operations that may be helpful in the user's workflow. For example, when searching in a browser window for an image to use in a presentation about highways, a system can present suggestions including links to other image galleries used by the user or other users for presentations.

In at least one implementation, the disclosed technology predicts and presents a next operation for a set of associated application windows. An operation prediction system adds multiple associated application windows to the set, generates a prediction of one or more next operation options based on the associated application windows of the set, presents one or more controls to the one or more next operation options in the user interface of the computing device, detects user selection of a control of the presented next operation options, executes in the set the next operation option corresponding to the selected control, responsive to the detecting operation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example set window providing next operation prediction for the set window.

FIG. 2 illustrates an example set window in which multiple likely next operations are presented via a smart palette control.

FIG. 3 illustrates another example set window in which multiple likely next operations are presented via a smart palette control.

FIG. 4 illustrates an example flow of operations for next operation prediction for a set window.

FIG. 5 illustrates an example system for next operation prediction for a set window.

FIG. 6 illustrates example operations for next operation prediction for a set window.

FIG. 7 illustrates an example computing device that may be useful in implementing the described technology.

### DETAILED DESCRIPTIONS

When working within a given workflow, a user may combine multiple application windows into a set of associated application windows representing an organization of activities to support that workflow. In some implementations, the set of windows may constitute a “set window,” as described herein, although other implementations may form a set of associated application windows using a shared property (such sharing a tag, being open in a common desktop or virtual desktop, or being part of a sharing session within a collaboration system) or other association technique. When reading a description of a figure using the term “set window,” it should be understood that a set window or any set of associated application windows may be employed in the described technology.

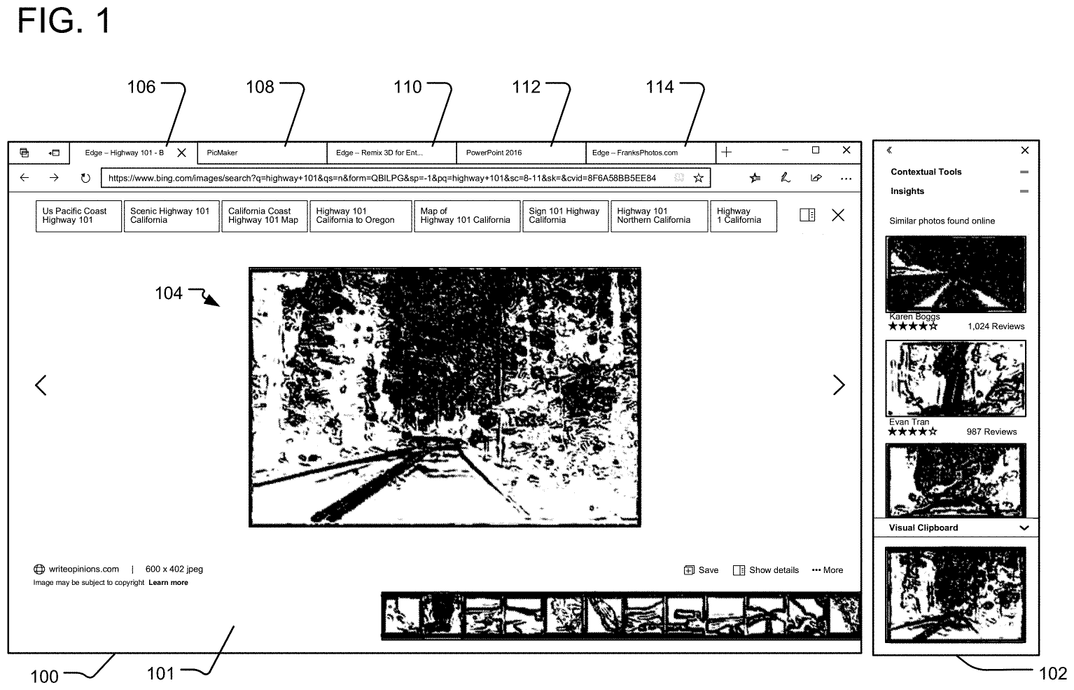

Multiple application windows can allow a user to collect, synchronize, and/or persist the applications, data, and application states in the given workflow, although all sets of associated application windows need not provide all of these benefits. For example, a user who is developing a presentation may be working with a set of associated application windows that includes a presentation application window, a browser application window presenting results of a web search for images, an image editor application window, and a browser application window presenting images for purchase through a gallery website. In this manner, the set of associated application windows may be displayed, stored, shared, and executed as a cohesive unit, such as in a tabbed set window, as shown in FIGS. 1, 2, and 3, or some other user interface component providing functional and visual organization to such associated application windows.

The described technology is provided in an environment in which a set of associated applications windows are grouped to interact and coordinate content and functionality among associated application windows, allowing a user to more easily track their tasks and activities, including tracking content interactions through interaction representations, in one or more computing systems in a set window of the associated application windows. An interaction representation is a structured collection of properties that can be used to describe, and optionally visualize or activate, a unit of user-engagement with discrete content using a computing system or device, including a particular application window used to access the content. The content can be internal content to one or more applications (e.g., an image editing application) or external content (e.g., images from an image gallery website accessible by a browser application). In some implementations, the application and/or content may be identified by a URI (Universal Resource Identifier).

As will be described in more detail, the disclosed technologies relate to collecting data regarding user interactions with content, organizing the information, such as associating user actions with a single activity, rather than as a series of isolated actions and grouping one or more interaction representations in a set (which can represent a task), and providing user interfaces that enable the user to review interaction representations to find information of interest, and to resume a particular activity or set of activities (e.g., the activities associated with a task). In order to further assist an individual in locating a particular content interaction, or to otherwise provide context to an individual regarding user activities, the disclosed technologies can include displaying interaction representations in association with navigational mnemonics.

The disclosed technologies also relate to collections, or sets, of one or more interaction representations. Such collections or sets can also be referred to as tasks. For convenience, the term “task” is generally used in the following discussion, where the term can refer to a collection or set of one or more interaction representations. In particular implementations, a task includes (or is capable of including) multiple interaction representations. Typically, the activities of the collection or set are related in some manner, such as to achieve a particular purpose (e.g., the “task”). However, no particular relationship between interaction representations in the set or collection for the “task” is required. That is, for example, a user may arbitrarily select activities to be included in a set or collection and, as the term is used herein, may still be referred to as a “task.”

Although a task typically includes a plurality of interaction representations, a task can include a single interaction representation. A task can also include other tasks or sets. Each task is typically a separate entity (e.g., a separate instance of an abstract or composite data type for an interaction representation) from the component interaction representation. For instance, a user may start a task with a particular interaction representation but may add additional interaction representations to the task as the user works on the task. In general, interaction representations can be added or removed from a task over time. In some cases, the adding and removing can be automatic, while in other cases the adding and removing is manually carried out by a user (including in response to a suggestion by a computing device to add or remove an interaction representation). Similarly, the creation of tasks can be automatic, or tasks can be instantiated by a user in particular ways. For instance, a software component can monitor user activities and suggest the creation of a task that includes interaction representations the software component believes may be related to a common purpose. The software component can employ various rules, including heuristics, or machine learning in suggesting possible tasks to be created, or interaction representations to be added to an existing task.

An interaction representation can include or be in the form of a data type, including a data type that represents a particular type of user interaction (e.g., an activity, or a task or workflow, which can include multiple activities). Data types can be useful for a particular application using interaction representation, including providing particular user interface/view of user interactions with relevant content. An interaction representation can be a serialized interaction representation or timeline, where the serialized interaction representation of a user's interaction with content, which can be useful in sending the information to other applications and or other computer devices. A serialized interaction representation, in particular implementations, may be in XML, or JSON format.

FIG. 1 illustrates an example set window 100 (an example set of associated application windows) providing next operation prediction for the set window 100. The visible application window is a browser window 101 within the set window 100 and displays an image 104 found through an image search. In the illustrated example, the user has opened the five application windows in the set window 100 to support a presentation editing workflow using the PowerPoint® presentation application associated with a tab 112. The browser window 101 is indicated by the active tab 106, and four hidden applications windows are indicated by the inactive tabs 108, 110, 112, and 114. The user can switch to any of the hidden application windows of the set window 100 by selecting one of the tabs or employing another window navigation control. It should be understood that individual application windows may be “detached” from the set window (e.g., removed from the displayed boundaries of the set window) and yet remain “in the set window” as members of the associated application windows of the set window 100.

The user interface of FIG. 1 shows a smart palette control 102 to the right of the set window 100. The smart palette control 102 supports the workflow associated with the set window 100 by providing supporting tools and processes, including without limitation contextual tools, insights, and a visual clipboard. In FIG. 1, the operation prediction system presents one or more predicted next operations in the smart palette control 102, although predicted next operations may be presented to a user via other user interface functionality in different implementations.

The user may employ the functionality and content of visible and hidden application windows of the set window to support the presentation editing portions of the user's workflow. As such, the set window provides application windows for an image editing application and various content sources, although other application can be added (e.g., a 3D object creation application window, an audio or video editing application window). For example, in FIG. 1, the image search of browser window 101 and the browser window at tab 106, displaying a webpage from FranksPhotos.com, are being used in the user's presentation editing workflow to find and obtain relevant images for a presentation.

An operation prediction system can generate one or more contexts from one or more application windows within the set window and input the one or more contexts as input to a prediction model that predicts one or more next operations for the set window that the user is likely to want to perform. The operation prediction system collects contextual information for the set window, including without limitation:
the identity of the applications executing in the application windows
content and/or activity of or within active and inactive application windows of the set window (e.g., open files in an application window or a browsing activity on a website in a browser application window)
contemporaneous and historical tracked user activity within the set window (e.g., operations executed by the user in one or more of the application windows)
historical tracked application identities, content, and activity of other users in the set windows having similar characteristics

On the basis of this contextual information, the operation prediction system can predict from a set of available operations to the set window likely next operations for the user's workflow and present them to the user, such as in the smart palette control 102 or another controls or processes. In this manner, a likely next operation is readily available to the user within the user interface, rather than requiring the user to navigate through menus, execute keyboard short-cuts, or select operations from a complicated set of operations in a ribbon or launcher. In some scenarios, the described technology can increase user efficiency by providing an intelligent user interface that anticipates the user's workflow needs and surfaces corresponding functionality that the user to utilize to address those needs. In other scenarios, such prediction and presentation of likely next operations can serve as a discovery tool, offering the user functionality of which the user was not aware.

In one implementation, the operation prediction system monitors user activity within the set window 100. The operation prediction system can monitor the applications running in the associated application windows of the set window 100, wherein the identities of the corresponding applications (e.g., image editor, presentation editor, the Outlook email and calendaring application) may be used as sources of contextual data to be used by the operation prediction system. The executing functions and content of the application windows can also provide contextual data for the operating prediction system. For example, (1) a browser window displaying an image gallery website and (2) a presentation editor window in which the user is editing a presentation entitled “California Highway 101” may provide at least two elements of contextual data. In this example, the operation prediction system may use this contextual data to predict that the user's next operation will be to search for other images relating to the “California,” “highways,” “roads,” “cars,” etc.

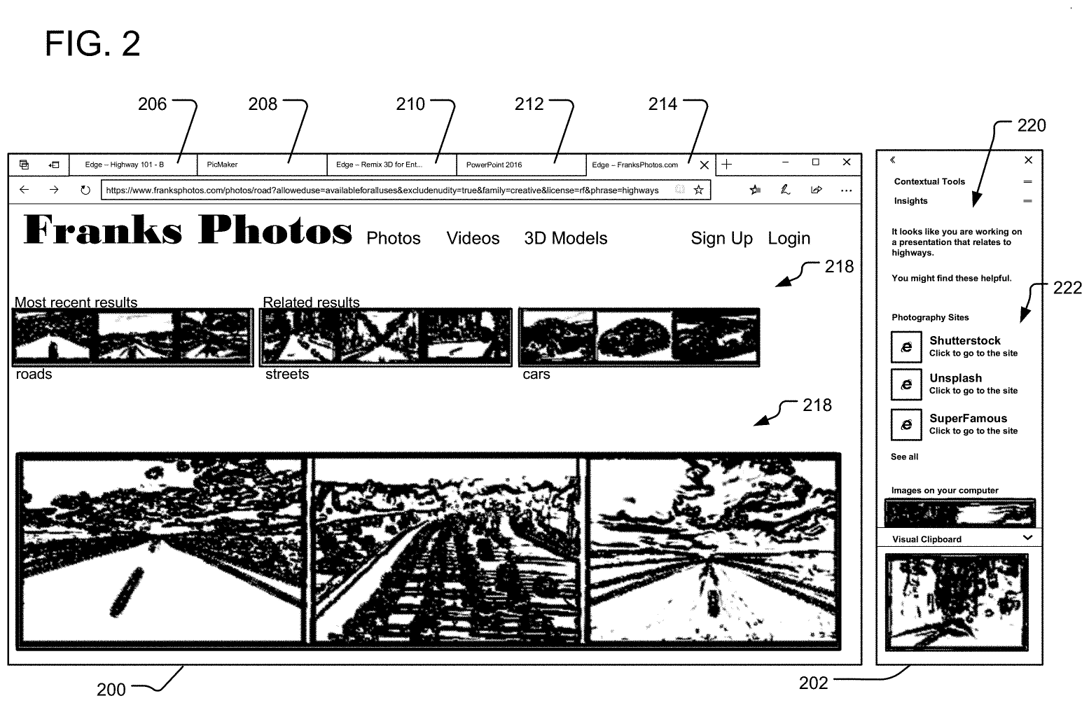

In some implementations, the operation prediction system can also track the user's contemporaneous and historical tracked activities with these applications windows of this set window and other similar set windows. For example, a user's workflow may be to open a new presentation in a presentation editing application, create several new slides, and then start adding images to the slides. If the user tends to execute this sequence of steps often, the operation prediction system can, through machine learning, predict that the user will wish to search for images when editing presentation slides in this workflow or future workflows. Accordingly, the operation prediction system can present links or controls in the smart palette control 102 offering navigation to various image galleries on the Web or a repository of images maintained locally or remotely by the user (see, e.g., the next operations presented in the smart palette control 202 of FIG. 2).

One set window characteristic that may be considered in determining a user intent is to grant an application window that is active (e.g., in focus) in the set window a higher priority in the machine learning model than any inactive (e.g., not in focus) application windows in the set window. In this manner, the predicted next operation is more likely to be related more heavily to the current in-focus application window, while still being informed by the other application windows in the set window.

In some implementations, the operation prediction system may aggregate the historical tracked activity of other users in similar set windows and/or with similar application windows and workflows. The operation prediction system may, through machine learning, use such aggregated activity to predict a next operation for the user. For example, the operation prediction system may detect that other users who are researching a travel destination tend to contact their friends who have traveled to the same destination. Accordingly, when a user is researching a travel destination via a travel or lodging website, the operation prediction system may cause the smart palette control 102 to present the current user with a selection of his or her friends who have traveled to that destination and offer a set of next operations for calling, email, or messaging any one of those friends. Likewise, the community of users may favor a certain image gallery for landscape images, and the smart palette control 102 can present a link to the website for that image gallery when the current user is editing a presentation entitles “Winter Scenes.” Other example use cases may be employed.

Presentation of likely next operations may be triggered in a variety of ways. In one implementation, contextual data is monitored, extracted, and evaluated continuously, periodically or at different times throughout a user's activity in a set window. When the operation prediction system has generated a next operation prediction that satisfies a confidence condition (e.g., has a confidence score that exceeds a threshold), the predicted next operation may be presented in the smart palette control 102. In some implementations, the context extraction and/or presentation of next operations may be triggered by user activity. For example, when a user selects a different application window in the set window, the operation prediction operation may trigger the context extraction and/or next operation presentation. In the workflow represented in FIG. 1, the user has searched for the image 104 and decides that it may be a possible candidate for the presentation, but the operation prediction system can trigger presentation of other possible image gallery search websites in the smart palette, as shown in smart palette control 202 of FIG. 2.

Contextual data may be extracted in a variety of techniques. Contextual data may be extracted from image content of the image 104 using pattern recognition (e.g., facial or text recognition). In addition, contextual data may be extracted from the search query employed in a browser window. For example, context may be extracted from metadata stored in association with the image 104 (e.g., image title, image resolution, image size, keywords, a date/time stamp, geolocation data). An example of such metadata may include elements from the URI for the browser window 114, particularly the search terms “highway” and “101”:
https://www.bing.com/images/search?q=highway+101&qs=n&form=QBILPG&sp=-1&pq=highway+101&sc=8-11&sk=&cvid=8F6A58BB5EE84
   Other metadata may be extracted from EXIF information associated with the image 104. The EXIF information may be copied in raw form to the smart palette control 102, and the context elements may be extracted from the visual clipboard, or contextual elements may be extracted from the EXIF information and then stored to the visual clipboard in association with the image 104.

The contextual data extracted from the set window 100 is used as input to the operation prediction system to predict and present a selection of one or more likely next operation to the user, such as through the smart palette control 102.

FIG. 2 illustrates an example set window 200 in which multiple likely next operations are presented via smart palette control 202. The context data extracted from the associated application windows of the set window 200 inform the operation prediction system about possible user intent regarding a next operation within the set window 200. By analyzing these factors, such as via a machine learning subsystem, the operation prediction system can predict one or more likely next operations the user may wish to execution in the set window 200.

In the illustrated example, after viewing the set windows shown and described with regard to FIG. 1, the user in FIG. 2 has executed an image search in a browser window 214 (i.e., a browser window associated with a tab 214) as the visible application window within the set window 200. The four other application windows of the set window 200 are shown as hidden windows associated with tabs 206, 208, 210, and 212 to support a presentation editing workflow using the PowerPoint® presentation application associated with the tab 212. The user can switch to any of the hidden application windows of the set window 200 by selecting one of the tabs or employing another window navigation control.

The search on the website of the browser window 214 within the set window 200 results in the browser window 214 displaying results of an image search in the browser window 214 based on the following query:
https://www.franksphotos.com/photos/road?alloweduse=availableforalluses&exclud enudity=true&family=creative&license=rf&phrase=highways

The operation prediction system has been tracking the user's activity in the set window, the associated application windows of the set window, etc. and determined with sufficient confidence an understanding of the user's intent, as evidenced by the messages 220 in the smart palette control 202.
It looks like you are working on a presentation that relates to highways. You might find these helpful.

In the described implementation, the operation prediction system determines such intent and predicts one or more likely next operations using one or more intelligence modules for extracting user intent from the variety of context inputs described here. Accordingly, given the inputs of an image editing application and a presentation editing application, the one or more intelligence modules can predict that the user intends to search for “photos” (or images) rather than for “3D models” or “videos,” which are also available through FranksPhotos.com. Results 218 of the photo search query on the FranksPhoto.com website are displayed in the browser window 214. In a different set window that includes a video editing application window, the operation prediction system may have extracted user intent that points to a video search, rather than a photo search, or both a video search and a photo search.

The smart palette control 202 presents controls to likely next operations at region 222, including links to other image gallery websites and locally-stored images with “highway”-related images and accessible by the user. By selecting one of the next operation controls, the user can execute a process to open a new browser or image editing window within the set window 200 to access new content and functionality and continue with his or her workflow.

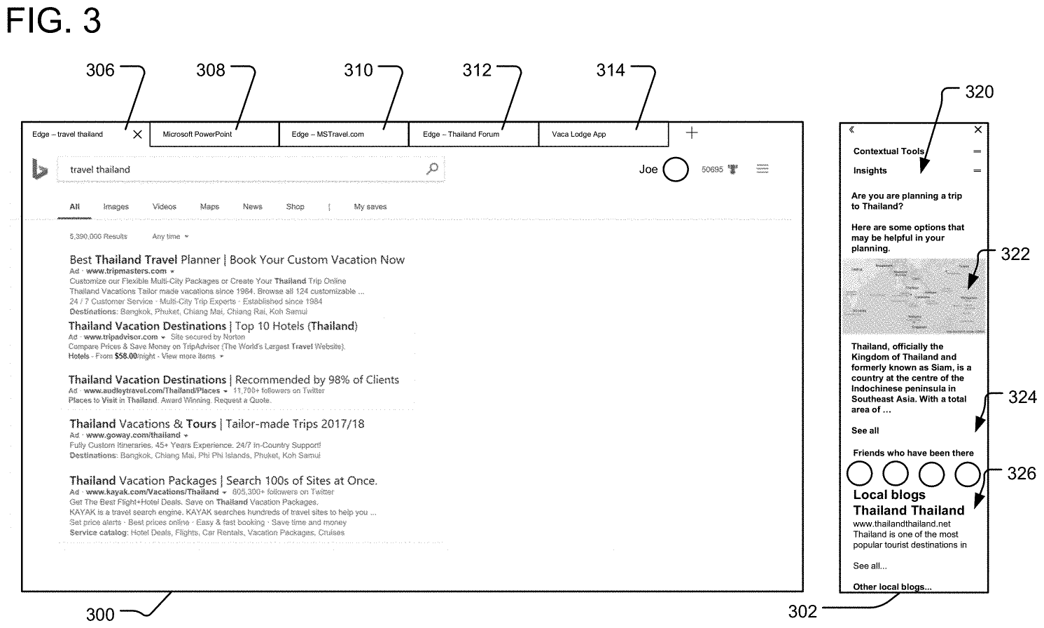

FIG. 3 illustrates another example set window 300 in which multiple likely next operations have been presented via a smart palette control 302. Five application windows of the set window 300 are shown with tabs 306, 308, 310, 312 and 314 to support a presentation editing workflow using the PowerPoint® presentation application associated with the tab 308. The user can switch to any of the application windows of the set window 300 by selecting one of the tabs or employing another window navigation control.

Responsive to the evaluation of the associated application windows in the set window 300 (e.g., application identities, window content, functional state) and tracked activity of the user and potentially other users, an operation prediction system has determined a potential user intent with sufficient confidence, and identified by message 320 presented in the smart palette control 302:
Are you are planning a trip to Thailand?
Here are some options that may be helpful in your planning.

Responsive to determining the user intent with sufficient confidence, the operation prediction system also presents multiple likely next operations:
Presenting in a region 322 of the smart palette control an excerpt of Thai information including a map and summary information about Thailand, including a “see all” link to open a browser window to the source website
Presenting in a region 324 of the smart palette control multiple contact controls for “Friends who have been there” to open an email, phone, or messaging application window (or control) in the set window
Presenting in a region 326 of the smart palette control an excerpt of a local Thai blog, including a “see all” link to open a browser window to the source website and an “Other local blogs” link perform a Web search to other blogs about Thailand

In one implementation, available operations are collected locally or in a server environment from operations previously-executed by the user (whether in the same set window 300 or other set windows) and/or by other users. In another implementation, available operations are identified by a system and/or Web search for operations that are sufficiently relevant to the context extracted from the set window (e.g., operations that satisfied a confidence condition). The likely next operation candidates from this available operations set are presented to the user in the smart palette control 302 with functionality to execute the selected operation in the set window 300.

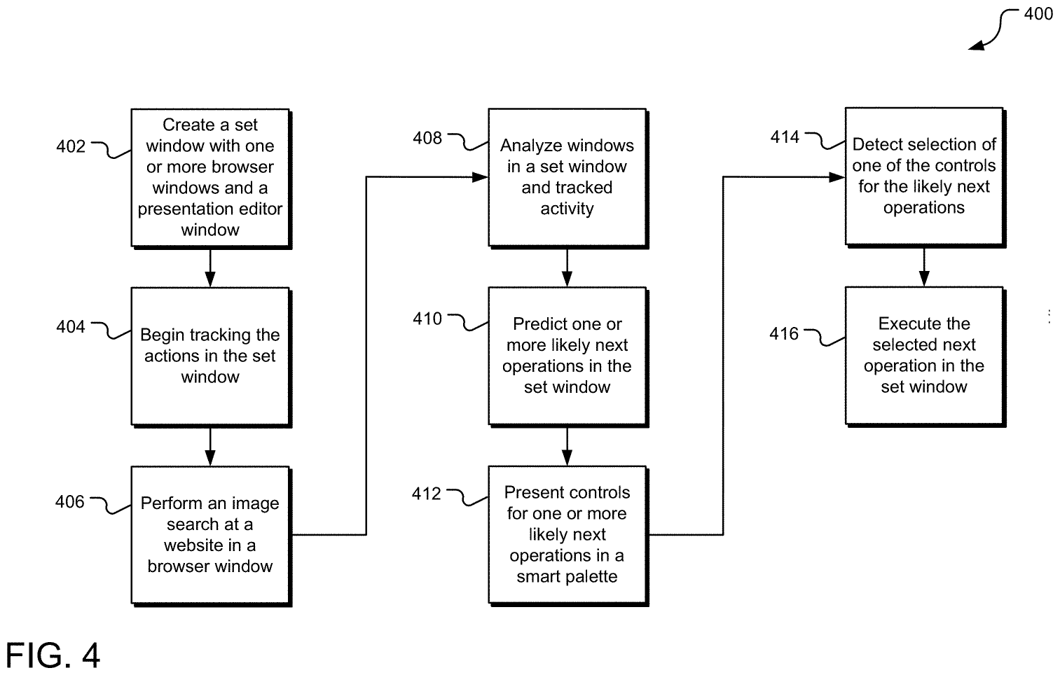

FIG. 4 illustrates an example flow of operations 400 implementing a next operation prediction for a set window. A creation operation 402 creates a set window with one or more associated application windows. In the example shown in FIG. 4, the set window includes one or more browser windows and a presentation editor window. A tracking operation 404 initiates tracking of user activity in the set window. In some implementations, tracking operation 404 may be relatively continuous, periodic, or triggered by other factors, and may extend to the activities of other users in similar set windows (e.g., set windows having similar tracked user activities, application windows, and content).

A user activity operation 406 invokes a search for an image at the associated image gallery website through one of the browser windows. The invoked search activity by the user is tracked by the operation prediction system. An analysis operation 408 analyzes the associated application windows in the set window and the tracked activities of the user in the set window (and potentially of other users in similar set windows). In one implementation, the analysis operation 408 inputs the characteristics of the set windows and the tracked user activities into a machine learning subsystem that determines, subject to a confidence condition, one or more likely next operations of the user in the set window as part of a prediction operation 410. A presentation operation 412 presents controls for the one or more likely next operations in the smart palette (or another user interface element). A detection operation 414 detects selection of at least one of the presented controls for the likely next operations, with the options of allowing selection of multiple presented controls. An execution operation 416 executes operation(s) corresponding to the selected control(s). For example, selection of the “see all” link of region 322 of FIG. 3 opens a new browser window in the set window and navigates to the website from which the excerpt map and text were sourced. In another example, selection of one of the contact controls in region 324 of FIG. 3 opens a new communication application window in the set window, with options to communicate with the selected contact via available mechanisms, such as email, phone, and messaging.

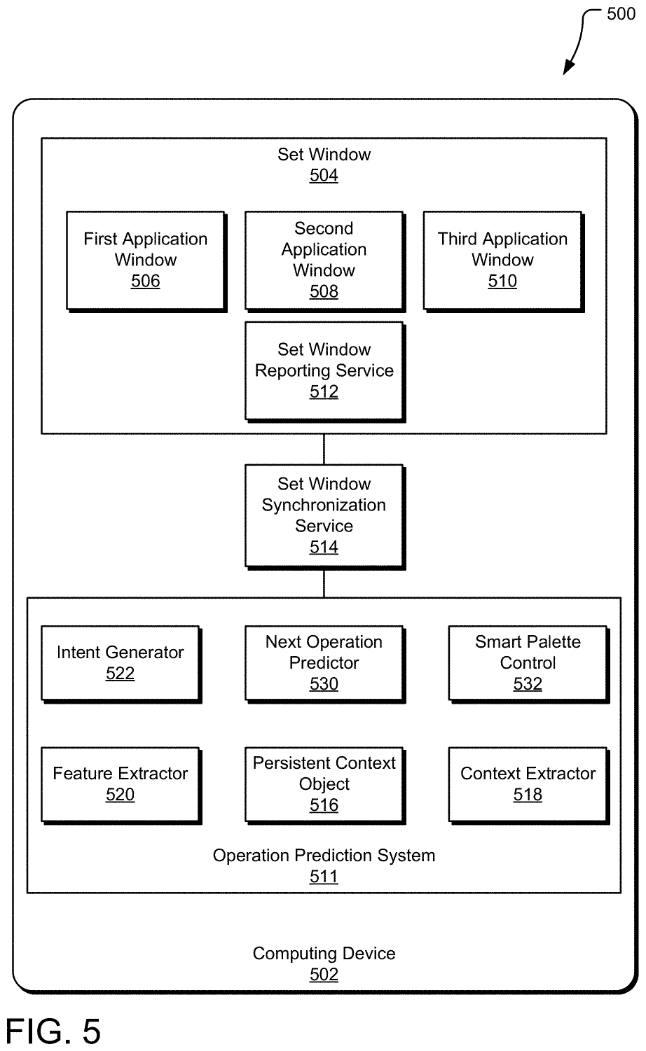

FIG. 5 illustrates an example system 500 for next operation prediction for a set window. A computing device 502 includes a set window synchronization service 514 (or a set synchronization service), which manages a set window 504 and the associated application windows (such as a first application window 506, a second application window 508, and a third application window 510) within the set window 504. A set window reporting service 512 can collect information reported by the application windows 506, 508, and 510, such as through an interface, and send the information to a set window synchronization service 514 of the computing device 502 (or any other computing device that hosts a set window synchronization service. The set window reporting service 512 and/or the set window synchronization service 514 may also be used to track user activity and/or provide feedback regarding predicted intents and presented operation successes.

The computer devices can be connected through a communications network or cloud (e.g., being connected through an internet, an intranet, another network, or a combination of networks). In some cases, the set window reporting service 512 can also send information to other computing devices, including those that include robust implementations of interaction representation and navigational mnemonic monitoring or reporting. The set window reporting service 512 can allow applications to make various calls to an interface, such as an interface that provides for the creation or modification of information regarding interaction representations, including information stored in one or more of task records, activity records, history records, and navigational mnemonic records (e.g., the task records, activity records, history records, and navigational mnemonic records, or interaction representations).

The set window synchronization service 514 can collect interaction representations from one or more of the computer devices. The collected information may be used to update interaction representations stored on one or more of the computer devices. For example, the computer devices may represent mobile devices, such as smartphones or tablet computers. A computer device may represent a desktop or laptop computer. In this scenario, the set window synchronization service 514 can send information regarding the mobile devices (e.g., interaction representations) to the desktop/laptop, so that a user of the desktop/laptop can be presented with a comprehensive view of their content-interactions across all of the computer devices, including relative to navigational mnemonics that may be common to multiple computing devices or specific to a particular computer device. In other scenarios, the computing devices may also be sent information regarding interaction representations on other computer devices.

The set window synchronization service 514 can carry out other activities. For instance, the set window synchronization service 514 can supplement or augment data sent by one computer device, including with information sent by another computer device. In some cases, the aggregation/synchronization component can associate history records for an activity carried out on one computer device with a task having another activity carried out using another of the computer devices.

The set window synchronization service 514 can also resolve conflicts between data received from different computing devices. For instance, conflicts can be resolved using a rule that prioritizes interaction representations or navigational mnemonics from different devices, prioritizes interaction representations or navigational mnemonics based on when the interaction representations or navigational mnemonics were generated, prioritizes interaction representations or navigational mnemonics based on a reporting source, such as a particular application or a shell monitor component, such as if two computer devices include interaction representations for the same activity at overlapping time periods.

For example, if a user was listening to music on two computer devices, the playback position in the same content may differ between the devices. The set window synchronization service 514 can determine the appropriate playback position to associate with the activity. Thus, set window synchronization service 514 can determine “true” data for an interaction representation, and can send this information to one or more of the computer devices, including a computer device on which the activity was not carried out, or updating data at a device where the activity was carried out with the “true” data.

In particular implementations, information from interaction representations and navigational mnemonics can be shared between different users. Each user can have an account in the computing device, such as stored in a database. Records for interaction representations (including history records therefor) and navigational mnemonics can be stored in the database in association with an account for each user. Persisting interaction representations and navigational mnemonics in a remote computing system can be beneficial, as it can allow interaction representations and navigational mnemonics to be provided to the user, without including a file-representation that needs to be managed by a user. When information for an interaction representation or navigational mnemonic is received and is to be shared with one or more other users, the shared information can be stored in the accounts for the other users, such as using collaborator identifiers.

The distribution of information between different user accounts can be mediated by the set window synchronization service 514. In addition to distributing information to different accounts, the set window synchronization service 514 can translate or format the information between different accounts. For instance, certain properties (e.g., applications used for various types of files, file paths, account information, etc.) of interaction representations or navigational mnemonics may be specific to a user or specific devices of the user. Fields of the various records can be replaced or updated with appropriate information for a different user. Accordingly, a user account can be associated with translation rules (or mappings) defining how various fields should be adapted for the user.

The set window synchronization service 514 can also synchronize data needed to use any records received from another user, or from another device of the same user. For instance, records shared with a user may require an application or content not present on the user's device. The aggregation/synchronization component can determine, for example, whether a user's computing device has an appropriate application installed to open content associated with an interaction representation. If the application is not present, the application can be downloaded and installed for the user, or the user can be prompted to download and install the application. If the content needed for a record is not present on the user's computing device, the content can be sent to the user's computing device along with the record, or the user can be prompted to download the content. In other examples, interaction representations can be analyzed by a receiving computer device, and any missing content or software applications downloaded or installed (or other actions, such as prompting a user to download content or install applications) may be collected by the receiving computer device.

In the case of navigational mnemonics for the same content-interaction carried out at different computer devices, in particular implementations, an interaction representation can be simply associated with all of the navigational mnemonics. In some cases, a record for a navigational mnemonic can include an identifier of a device on which the navigational mnemonic was generated, or with which the navigational mnemonic is associated (for instance, a location visited by the user as detected by a smartphone in the user's possession). Thus, this navigational mnemonic may be associated with both the determined location and the particular computing device.

An operation prediction system 511 provides functionality for next operation prediction in a set window. A persistent context object 516 represents a storage object in which contextual content may be shared among the application windows 506, 508, and 510. In various implementations, the persistent context object 516 may include cut-n-paste functionality and storage, drag-n-drop functionality and storage, and/or any other functionality that will allow multiple applications executing in a set window to share data. The contextual content as well as individual context elements, such as used in a context seeding operation, may be communicated among multiple applications via such a persistent context object 516. A context extractor 518 accesses the contextual content stored within the persistent context object 516 and extracts one or more context elements, such as by extracting context elements from metadata associated with the contextual content (e.g., EXIF information associated with an image). A feature extractor 520 extracts features from the contextual content via pattern recognition (e.g., a road, spoken words, a sign, a license plate, a car type. Such features (e.g., text extracted from an image, words extracted from an audio file, a color or color scheme) or labels for such features (e.g., the name of a person recognized in an image) can then be included in the extracted context. Other contexts may be extracted from the set window 504, such as from applications executing within the set window 504, content open in the application windows of the set window 504, etc.

An intent generator 522 can evaluate such varied characteristics of the set window 504 (e.g., using machine learning or other prediction technologies) to infer user intent as to the next operation to be executed within the set window. Based on the inferred user intent, a next operation predictor 530 predicts (e.g., using machine learning or other prediction technologies) one or more likely next operations to present to the user. A smart palette control 532 presents the one or more likely next operations and collects operation selections and potentially user feedback.

Accordingly, the system 500, using one or more of the components described herein can use from the associated application windows of the set window 504 to develop context for use in predicting and presenting one or more likely next operations for the set window 504. Alternatively, or additionally, the system 500 can also use tracked user activity, whether from the current user or other users, to generate an intent context assisting in the prediction of one or more likely next operations in the user's workflow.

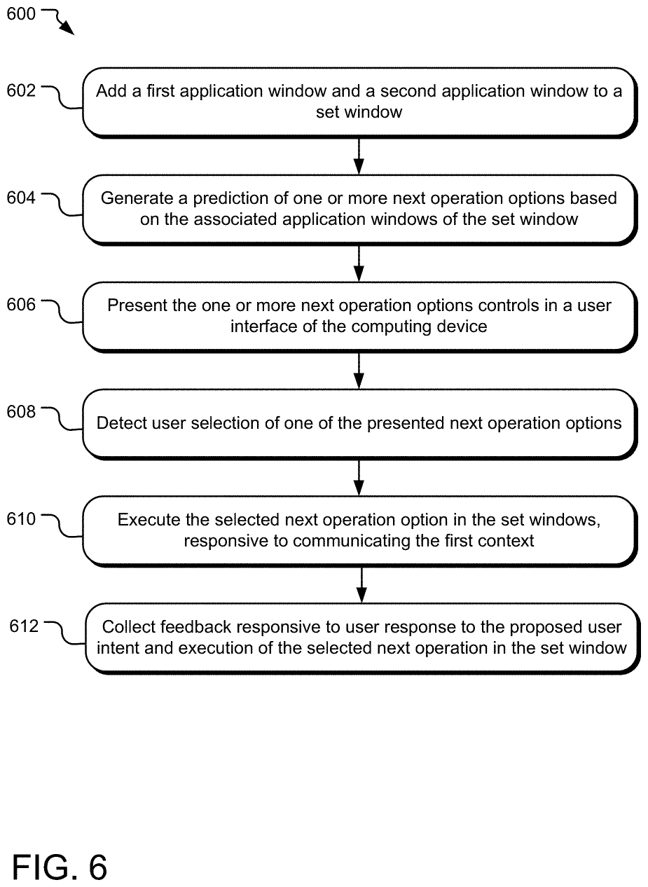

FIG. 6 illustrates example operations 600 for next operation prediction for a set window. An adding operation 602 adds multiple associated application windows to the set window. A generating operation 604 generates a prediction of one or more likely next operation options based on the associated application windows of the set window. The generating operation 604 can use various inputs and conditions from the set window to predict the one or more likely next operation options. In one implementation, the generating operation 604 includes a context collection operation that collects contexts from the set window, including without limitation from application window identities (e.g., browser window, image editing application window), application window content, application window states (e.g., displaying a search query screen, displaying a search result screen, in color adjustment mode of an image editor, in presentation mode of a 3D content editor), and other set window characteristics.

In one implementation, the generating operation 604 also includes a user activity tracking operation that tracks user activity within the set window or a similar set window. The generating operation 604 may also collect tracked user activity of other users within similar set windows to provide an aggregated perspective on how users work within similar workflows. Such information can provide a more robust machine-learning model for next operation prediction, and a system based on a single user alone.

Based on these various inputs, the generating operation 604 uses a machine learning subsystem (employing a machine learning model) to predict one or more user intents (e.g., planning to travel to Thailand, preparing a presentation on highways) and presents the predicted intent(s) to the user through a smart palette control or other user interface element of the computing device. The generating operation 604 may solicit user feedback indicating the accuracy of the predicted user intent(s) presented to the user.

In one implementation, the generating operation 604 uses a machine learning subsystem (employing a machine learning model) to predict one or more likely next operations, subject to a confidence condition and based on the predicted user intent and potentially collected contexts relating to the set window (e.g., set window characteristics, tracked user activity). A presenting operation 606 presents the one or more next operation options, such as through a smart palette control or other user interface element.

A selection operation 608 detects selection of one of the presented next operation options. An execution operation 610 executes the selected next operation option in the set windows, responsive to the selection operation 608. A feedback operation 612 collects feedback responsive to user response to the proposed user intent and/or execution of the selected next operation in the set window to improve the machine learning models relating to user intent and next operations.

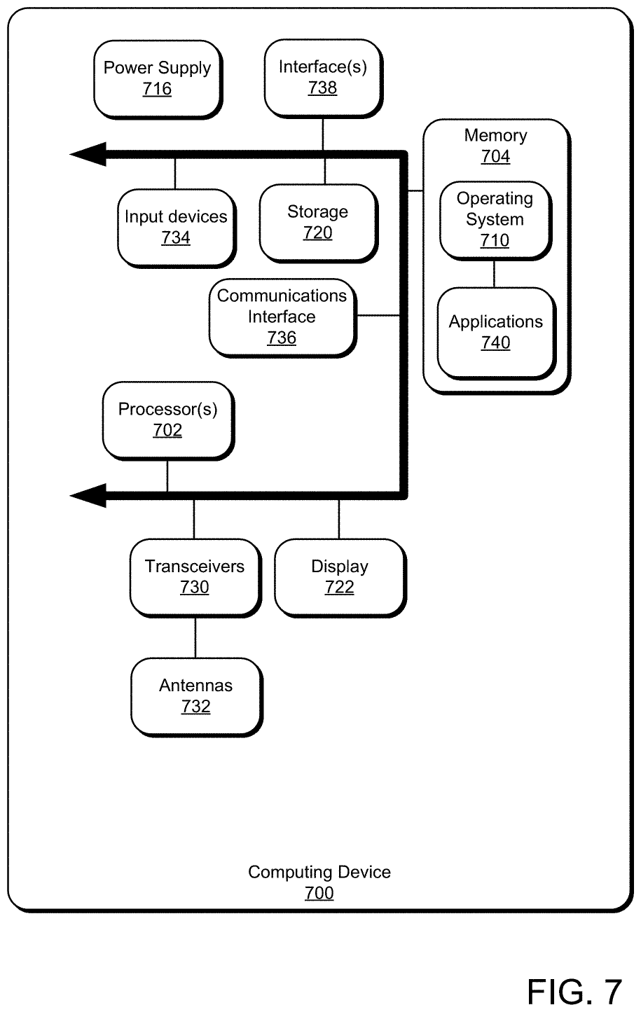

FIG. 7 illustrates an example computing device 700 that may be useful in implementing the described technology to predict a next operation for a set window. The example computing device 700 may be used to detect the proximity of an object with respect to an antenna, such as inter-application context seeding. The computing device 700 may be a personal or enterprise computing device, such as a laptop, mobile device, desktop, tablet, or a server/cloud computing device. The computing device 700 includes one or more processor(s) 702, and a memory 704. The memory 704 generally includes both volatile memory (e.g., RAM) and non-volatile memory (e.g., flash memory). An operating system 710 and one or more applications 740 may reside in the memory 704 and be executed by the processor(s) 702.

One or more modules or segments, such as an intent generator, a feature extractor, a context extractor, a next operation predictor, a smart palette control, and other components are loaded into the operating system 710 on the memory 704 and/or storage 720 and executed by the processor(s) 702. Data such as user preferences, contexts, tracked user activity, set window characteristics, interactive representation, and other data and objects may be stored in the memory 704 or storage 720 and may be retrievable by the processor(s). The storage 720 may be local to the computing device 700 or may be remote and communicatively connected to the computing device 700.

The computing device 700 includes a power supply 716, which is powered by one or more batteries or other power sources and which provides power to other components of the computing device 700. The power supply 716 may also be connected to an external power source that overrides or recharges the built-in batteries or other power sources.

The computing device 700 may include one or more communication transceivers 730 which may be connected to one or more antenna(s) 732 to provide network connectivity (e.g., mobile phone network, Wi-Fi®, Bluetooth®) to one or more other servers and/or client devices (e.g., mobile devices, desktop computers, or laptop computers). The computing device 700 may further include a network adapter 736, which is a type of communication device. The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard or mouse). These and other input devices may be coupled to the server by one or more interfaces 738 such as a serial port interface, parallel port, or universal serial bus (USB). The computing device 700 may further include a display 722 such as a touchscreen display.

The computing device 700 may include a variety of tangible processor-readable storage media and intangible processor-readable communication signals. Tangible processor-readable storage can be embodied by any available media that can be accessed by the computing device 700 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

In some implementations, the disclosed technology provides that interaction representations, such as a serialized interaction representation to timeline, can be supplied by an application (or a component of an operating system) in response to an external request. The external request can be a request from another software application or from an operating system. Providing interaction representations in response to external requests can facilitate user interface modalities, such as cut-and-paste or drag-and-drop, including in the creation of sets of associated application windows (e.g., sets of activity representations). When content is transferred to/from an application, it can be annotated with an interaction representation generated by the application (or operating system component) in response to the external request (e.g., generated by a user-interface command).

Interaction representations, in some implementations, can be updateable. Updates can be provided by an application that created an interaction representation, another application, or a component of the operating system. Updates can be pushed by an application or request from an application.

In some implementations, in addition to organizing component interaction representations, tasks can have additional properties that can assist a user. For example, the task may be represented by a user interface element that can be “pinned” or associated with various aspects of a graphical user interface—such as being pinned to a start menu, an application dock or taskbar, or a desktop. In addition, a user may choose to share tasks, or particular interaction representations of a task, such as in order to collaborate with other users to accomplish the task.

Sets can be associated with particular types, where a type can determine how sets are created and modified, and what information is included in a set. For instance, the set type can determine whether duplicate interaction representations (e.g., interaction representations associated with the same content, or the same content and the same application) can be added to a set, whether sets can be modified by a user, and whether information associated with an order or position of interaction representations in the set (e.g., a display position of content on a display device). A set type can also be used to determine what types of applications are allowed to use or modify the set (e.g., selecting to open a set may launch a different application, or application functionality, depending on the set type).

Sets, and interaction representations more generally, can also be associated with an expiration event (which could be the occurrence of a particular date or time or the passage of a determined amount of time), after which the set or interaction representation is deleted.

In order to further assist an individual in locating a particular interaction representation or task, or to otherwise provide context to an individual regarding user tasks and interaction representations, the disclosed technologies include displaying task and interaction representation information in association with navigational mnemonics. As used herein, a navigational mnemonic is information that is likely to be highly memorable to a user and can aid a user in determining whether tasks and interaction representations associated with the navigational mnemonic are, or are not, likely to be related to information they are seeking, or otherwise provide context to a display of task and interaction representation information. For instance, a user may associate a navigational mnemonic with tasks and content interactions carried out by the user in temporal proximity to a time associated with the navigational mnemonic. The time may be a time the navigational mnemonic occurred or a time that the user associates with the navigational mnemonic. The navigational mnemonic may be a significant news or entertainment event, such as the release date of a new blockbuster movie or the date of a presidential election.

Although the present disclosure generally describes navigational mnemonics used to locate past tasks and content interactions, navigational mnemonics can be provided regarding prospective tasks and interaction representations. For instance, images of a person or a location can be provided as navigational mnemonics proximate upcoming calendar items for a task or interaction representation.

As an example of a navigational mnemonic that is relevant to a particular user, a location, such as where the individual took a vacation, may be particularly memorable to the individual at various times, such as when they booked their vacation, or when they left for, or returned from, their vacation. Thus, some potential navigational mnemonics, such as news stories, may be relevant to a large number of individuals, while other navigational mnemonics may be relevant to a single individual, or may be relevant in different ways to different users. In various embodiments, a computer device (for example, an operating system of a computer device, or a component thereof), can select navigational mnemonics based on heuristics, user activity (including a particular user or a collection of users), using a determined feed service, using promotional sources, based on applications or services used or designated by a user, or combinations thereof.

Navigational mnemonics can be displayed proximate information regarding tasks and interaction representations that a user is likely to associate with the navigational mnemonic. If the individual recalls the task or activity they are looking for as “not associated with a displayed navigational mnemonic,” the user can scroll more quickly through the displayed tasks and interaction representations, including until the user recognizes a navigational mnemonic associated with the task or interaction representation they are seeking. If the user associates a displayed navigational mnemonic with a task or interaction representation of interest, the user can look more closely at associated tasks and interaction representations, including selecting to display more detailed information for tasks or interaction representation associated with the navigational mnemonic.

In at least some cases, interaction representations displayed to a user can include features that enable the user to provide input to resume the task or content interaction. For example, if the interaction representation represents watching a movie, the user can be presented with information regarding that activity, and, if the user selects the activity, the user may be taken to an application capable of displaying the movie (such as the application on which the movie was originally viewed), the movie can be loaded into the application, can be forwarded to the position where the user left off watching the movie, and playback can be resumed. For tasks, one or more of the constituent activities of the set of activities associated with the task can be resumed. In the scenario of a user resuming a work-related task, resuming the task might involve navigating to a particular web page using a web browser, loading a document in a word processing program, and loading a presentation in a presentation authoring program.

In some implementations, a task or activity (including one or more activities associated with a task) can be resumed at a device other than a device on which the task or activity was originally (or last) conducted, or the task or activity can be initiated at a device other than a device at which the task or activity will be resumed. Similarly, navigational mnemonics can be provided on one device that are associated with another device, including user tasks and activities on the other device.

Information regarding user tasks, interaction representations, and navigational mnemonics can be collected across multiple devices and distributed to devices other than the device on which the task or interaction representation was generated, including through an intermediate service or one of the computer devices that serves as a master repository for user data, or directly between devices. In particular cases, an intermediate service, such as a cloud-based service, collects interaction representation information from multiple computing devices of a user, and reconciles any differences between task and interaction representation information, and navigational mnemonics, from the devices. The intermediate service (or master device) can thus serve as an arbiter of “truth,” and can distribute task and interaction representation information, and navigational mnemonics, to the user's devices, including such that a particular device may be provided with interaction representation information and navigational mnemonics for other user devices, or updated information can be provided for the particular devices. In this way, displays can be provided that allow a user to view their activity, in association with one or more navigational mnemonics, across multiple computing devices. In a similar manner, the intermediate service can allow information to be shared between multiple users (each of which may be associated with multiple computer devices).

Thus, the disclosed technologies can provide a number of advantages, including:
interaction representations that can be generated by applications during their normal execution or in response to an external request;
interaction representations that can be converted between data type representations and serialized interaction representations;
modifying system data types (e.g., shareable data types) to support user interface actions such as copy and paste and drag and drop, including annotating content with information regarding associated interaction representations and transfer of interaction representations using such system data types;
interaction representations that include entity metadata, visualization information, and activation information;
interaction representations that can be associated with metadata schema of one or more types;
interaction representations that can include visualization information having various degrees of complexity;
interactions representations to which additional metadata fields can be associated, and metadata values modified;
interaction representations that can be shared across different devices and platforms, including between different operating systems;
interaction representations having updatable content or application information, which can help representations stay synchronized or up to date;
interaction representations that can represent collections of interaction representations;
collections of interaction representations having different types, where a type can be associated with particular properties or rules; and
collections of interaction representations, where the collection, or a member thereof, is associated with an expiration event.

These technologies relate to the technical field of computer science, as they collect, distribute, and arbitrate information relating to a user's tasks and content interactions on one or more computing devices and facilitate further user interaction. The disclosed serializable interaction representation can facilitate sharing information regarding user content interactions between applications and computing device. The disclosed technologies also provide for an application to generate an activity representation on demand, which can facilitate forming sets of interaction representations and supporting user interface actions, such as drag and drop and copy and paste.

An example method of predicting a next operation in a set of associated application windows of a computing device having a user interface includes adding multiple associated application windows to the set, generating a prediction of one or more next operation options based on the associated application windows of the set, presenting one or more controls to the one or more next operation options in the user interface of the computing device, detecting user selection of a control of the one or more presented next operation options, responsive to the presenting operation, and executing in the set the next operation option corresponding to the selected control, responsive to detecting operation.

Another example method of any preceding method is provided wherein the generating operation includes determining a context based on an identity of at least one of the associated application windows of the set and generating the prediction of one or more next operation options based on the context.

Another example method of any preceding method is provided wherein the generating operation includes determining a context based on content evaluated from at least one other application window of the set and generating the prediction of one or more next operation options based on the context.

Another example method of any preceding method is provided wherein the generating operation includes determining a context from at least one of the associated application windows of the set and generating the prediction of one or more next operation options based on the context.

Another example method of any preceding method is provided wherein the generating operation includes tracking user activity within the set, determining a context from the tracked user activity, and generating the prediction of one or more next operation options based on the context.

Another example method of any preceding method is provided wherein the generating operation includes collecting historical user activity of users of another similar set, determining a context from the collected historical user activity, and generating the prediction of one or more next operation options based on the context.

Another example method of any preceding method is provided wherein the generating operation includes predicting one or more user intents for a user workflow using one or more characteristics of the associated application windows of the set as input to a machine learning model.

Another example method of any preceding method is provided wherein the generating operation includes predicting the one or more likely next operations for a user workflow using the one or more predicted user intents and one or more characteristics of the associated application windows of the set as input to a machine learning model.

Another example method of any preceding method is provided wherein the multiple associated application windows include an active association window and one or more inactive application windows, and the generating operation includes designating a higher priority on user activity tracked within the active application window than in the one or more inactive application windows and generating the prediction of the next operation options based on at least one higher priority user activity tracked within the active application window and at least one lower priority lower activity tracked within the one or more inactive application windows.

An example system for predicting a next operation in a set of associated application windows of a computing device having a user interface includes one or more processors, a set synchronization service executed by the one or more processors and configured to add multiple associated application windows to the set, a next operation predictor coupled to the set synchronization service and configured to generate a prediction of one or more next operation options based on the associated application windows of the set, a user interface control coupled to the set synchronization service and configured to present one or more controls to the one or more next operation options in the user interface of the computing device, and a set reporting service executed by the one or more processors, coupled to the set synchronization service, and configured to detect user selection of a control of the one or more presented next operation options, wherein the set synchronization service further executes in the set the next operation option corresponding to the selected control.

Another example system of any preceding system further including a context extractor coupled to the set synchronization service and configured to determine a context based on at least one of the associated application windows of the set, and the next operation predictor is configured to generate the prediction of one or more next operation options based on the context.

Another example system of any preceding system further including a context extractor coupled to the set synchronization service and configured to track user activity within the set and determine a context from the tracked user activity, and the next operation predictor is configured to generate the prediction of one or more next operation options based on the context.

Another example system of any preceding system further including a context extractor coupled to the set synchronization service and configured to collect historical user activity of users of other similar set and to determine a context from the collected user historical activity, and the next operation predictor is configured to generate the prediction of one or more next operation options based on the context.

Another example system of any preceding system further including an intent generator coupled to the set synchronization service and configured to predict one or more user intents for a user workflow using one or more characteristics of the associated application windows of the set as input to a machine learning model, the next operation predictor being configured to predict the one or more likely next operations for a user workflow using the one or more predicted user intents and one or more characteristics of the associated application windows of the set as input to a machine learning model.

One or more example tangible processor-readable storage media of a tangible article of manufacture encoding processor-executable instructions is provided for executing on an electronic computing system a process of predicting a next operation in a set of associated application windows of a computing device having a user interface. The process includes adding multiple associated application windows to the set, generating a prediction of one or more next operation options based on the associated application windows of the set, presenting one or more controls to the one or more next operation options in the user interface of the computing device, detecting user selection of a control of the one or more presented next operation options, responsive to the presenting operation, and executing in the set the next operation option corresponding to the selected control, responsive to the detecting operation.

Other example tangible processor-readable storage media of any preceding storage media are provided wherein the generating operation includes determining a context based on at least one of the associated application windows of the set and generating the prediction of one or more next operation options based on the context.

Other example tangible processor-readable storage media of any preceding storage media are provided wherein the generating operation includes tracking user activity within the set, determining a context from the tracked user activity, and generating the prediction of one or more next operation options based on the context.

Other example tangible processor-readable storage media of any preceding storage media are provided wherein the generating operation includes collecting historical user activity of users of another similar set, determining a context from the collected historical activity, and generating the prediction of one or more next operation options based on the context.

Other example tangible processor-readable storage media of any preceding storage media are provided wherein the generating operation includes predicting one or more user intents for a user workflow using one or more characteristics of the associated application windows of the set as input to a machine learning model.

Other example tangible processor-readable storage media of any preceding storage media are provided wherein the generating operation includes predicting the one or more likely next operations for a user workflow using the one or more predicted user intents and one or more characteristics of the associated application windows of the set as input to a machine learning model.

Another example system for predicting a next operation in a set of associated application windows of a computing device having a user interface includes mean for adding multiple associated application windows to the set, mean for generating a prediction of one or more next operation options based on the associated application windows of the set, mean for presenting one or more controls to the one or more next operation options in the user interface of the computing device, mean for detecting user selection of a control of the one or more presented next operation options, responsive to the means for presenting, and mean for executing in the set the next operation option corresponding to the selected control, responsive to means for detecting.

Another example system of any preceding system is provided wherein the generating operation includes mean for determining a context based on an identity of at least one of the associated application windows of the set and mean for generating the prediction of one or more next operation options based on the context.

Another example system of any preceding system is provided wherein the generating operation includes mean for determining a context based on content evaluated from at least one other application window of the set and mean for generating the prediction of one or more next operation options based on the context.

Another example system of any preceding system is provided wherein the generating operation includes mean for determining a context from at least one of the associated application windows of the set and mean for generating the prediction of one or more next operation options based on the context.

Another example system of any preceding system is provided wherein the generating operation includes mean for tracking user activity within the set, mean for determining a context from the tracked user activity, and mean for generating the prediction of one or more next operation options based on the context.

Another example system of any preceding system is provided wherein the generating operation includes mean for collecting historical user activity of users of another similar set, mean for determining a context from the collected historical user activity, and mean for generating the prediction of one or more next operation options based on the context.

Another example system of any preceding system is provided wherein the generating operation includes mean for predicting one or more user intents for a user workflow using one or more characteristics of the associated application windows of the set as input to a machine learning model.

Another example system of any preceding system is provided wherein the generating operation includes mean for predicting the one or more likely next operations for a user workflow using the one or more predicted user intents and one or more characteristics of the associated application windows of the set as input to a machine learning model.

Another example system of any preceding system is provided wherein the multiple associated application windows include an active association window and one or more inactive application windows, and the mean for generating includes mean for designating a higher priority on user activity tracked within the active application window than in the one or more inactive application windows and mean for generating the prediction of the next operation options based on at least one higher priority user activity tracked within the active application window and at least one lower priority lower activity tracked within the one or more inactive application windows.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of predicting a next operation in a set of associated application windows of a computing device having a user interface, the method comprising:
adding multiple associated application windows to the set;
generating a prediction of one or more next operation options based on the associated application windows of the set;
presenting one or more controls to the one or more next operation options in the user interface of the computing device;
detecting user selection of a control of the one or more presented next operation options, responsive to the presenting operation; and
executing in the set the next operation option corresponding to the selected control, responsive to detecting operation.

2. The method of claim 1 wherein the generating operation comprises:
determining a context based on an identity of at least one of the associated application windows of the set; and
generating the prediction of one or more next operation options based on the context.

3. The method of claim 1 wherein the generating operation comprises:
determining a context based on content evaluated from at least one other application window of the set; and
generating the prediction of one or more next operation options based on the context.

4. The method of claim 1 wherein the generating operation comprises:
determining a context from at least one of the associated application windows of the set; and
generating the prediction of one or more next operation options based on the context.

5. The method of claim 1 wherein the generating operation comprises:
tracking user activity within the set;
determining a context from the tracked user activity; and
generating the prediction of one or more next operation options based on the context.

6. The method of claim 1 wherein the generating operation comprises:
collecting historical user activity of users of another similar set;
determining a context from the collected historical user activity; and
generating the prediction of one or more next operation options based on the context.

7. The method of claim 1 wherein the generating operation comprises:
predicting one or more user intents for a user workflow using one or more characteristics of the associated application windows of the set as input to a machine learning model.

8. The method of claim 7 wherein the generating operation comprises:
predicting the one or more likely next operations for a user workflow using the one or more predicted user intents and one or more characteristics of the associated application windows of the set as input to a machine learning model.

9. The method of claim 1 wherein the multiple associated application windows include an active association window and one or more inactive application windows, and the generating operation comprises:
designating a higher priority on user activity tracked within the active application window than in the one or more inactive application windows; and
generating the prediction of the next operation options based on at least one higher priority user activity tracked within the active application window and at least one lower priority lower activity tracked within the one or more inactive application windows.

10. A system for predicting a next operation in a set of associated application windows of a computing device having a user interface, the system comprising:
one or more processors;
a set synchronization service executed by the one or more processors and configured to add multiple associated application windows to the set;
a next operation predictor coupled to the set synchronization service and configured to generate a prediction of one or more next operation options based on the associated application windows of the set;
a user interface control coupled to the set synchronization service and configured to present one or more controls to the one or more next operation options in the user interface of the computing device; and
a set reporting service executed by the one or more processors, coupled to the set synchronization service, and configured to detect user selection of a control of the one or more presented next operation options, wherein the set synchronization service further executes in the set the next operation option corresponding to the selected control.

11. The system of claim 10 further comprising:
a context extractor coupled to the set synchronization service and configured to determine a context based on at least one of the associated application windows of the set, and the next operation predictor is configured to generate the prediction of one or more next operation options based on the context.

12. The system of claim 10 further comprising:
a context extractor coupled to the set synchronization service and configured to track user activity within the set and determine a context from the tracked user activity, and the next operation predictor is configured to generate the prediction of one or more next operation options based on the context.

13. The system of claim 10 further comprising:
a context extractor coupled to the set synchronization service and configured to track and collect historical user activity of users of other similar set and to determine a context from the collected user historical activity, and the next operation predictor is configured to generate the prediction of one or more next operation options based on the context.

14. The system of claim 10 further comprising:
an intent generator coupled to the set synchronization service and configured to predict one or more user intents for a user workflow using one or more characteristics of the associated application windows of the set as input to a machine learning model, the next operation predictor being configured to predict the one or more likely next operations for a user workflow using the one or more predicted user intents and one or more characteristics of the associated application windows of the set as input to a machine learning model.

15. One or more tangible processor-readable storage media of a tangible article of manufacture encoding processor-executable instructions for executing on an electronic computing system a process of predicting a next operation in a set of associated application windows of a computing device having a user interface, the process comprising:
adding multiple associated application windows to the set;
generating a prediction of one or more next operation options based on the associated application windows of the set;
presenting one or more controls to the one or more next operation options in the user interface of the computing device;
detecting user selection of a control of the one or more presented next operation options, responsive to the presenting operation; and
executing in the set the next operation option corresponding to the selected control, responsive to the detecting operation.

16. The one or more tangible processor-readable storage media of claim 15 wherein the generating operation comprises:
determining a context based on at least one of the associated application windows of the set; and
generating the prediction of one or more next operation options based on the context.

17. The one or more tangible processor-readable storage media of claim 15 wherein the generating operation comprises:
tracking user activity within the set;
determining a context from the tracked user activity; and
generating the prediction of one or more next operation options based on the context.

18. The one or more tangible processor-readable storage media of claim 15 wherein the generating operation comprises:
collecting historical user activity of users of another similar set;
determining a context from the collected historical activity; and
generating the prediction of one or more next operation options based on the context.

19. The one or more tangible processor-readable storage media of claim 15 wherein the generating operation comprises:
predicting one or more user intents for a user workflow using one or more characteristics of the associated application windows of the set as input to a machine learning model.

20. The one or more tangible processor-readable storage media of claim 19 wherein the generating operation comprises:
predicting the one or more likely next operations for a user workflow using the one or more predicted user intents and one or more characteristics of the associated application windows of the set as input to a machine learning model.
